(19) United States
(12) Patent Application Publication
(10) Pub. No.: US 2021/0008654 A1
(43) Pub. Date: Jan. 14, 2021

(54) FORMING DEVICE AND METHOD FOR SUPPLYING AT LEAST ONE ROOT PROTECTION GAS

(71) Applicant: Linde GmbH, Pullach (DE)

(72) Inventor: Sergej HALOSIN, Hamburg (DE)

(21) Appl. No.: 16/980,013

(22) PCT Filed: Feb. 11, 2019
(86) PCT No.: PCT/EP2019/025041

§ 371 Date: Sep. 11, 2020

(30) Foreign Application Priority Data
Mar. 19, 2018 (EP) 18020102.2

(51) Int. Cl. B23K 9/16; B23K 9/32

(52) U.S. Cl. CPC B23K 9/164; B23K 9/325

(57) ABSTRACT

The invention relates to a forming device (200) for supplying at least one root protection gas to the root side of at least one region (11) of at least one pipe (10) to be connected, comprising at least one root protection gas supply device (220) for supplying the root protection gas and comprising at least one root protection gas conducting device (210) for conducting or deflecting the supplied root protection gas in an axial direction along the inner wall of the pipe (10) along the root side of the region (11) to be connected, wherein the root protection gas conducting device (210) has a cylindrical shape and can be inserted into the pipe (10) in a centered manner, and the root protection gas supply device (220) is arranged within the root protection gas conducting device (210). The invention additionally relates to a method for forming or supplying at least one root protection gas to the root side of at least one region (11) of at least one pipe (10) to be connected. The supplied root protection gas is guided, conducted, or deflected in the direction along the inner face of the pipe (10) along the root side of the region to be connected, and the root protection gas is additionally guided in the radial direction such that when the pipe region is connected to a pipe bend (12), the root protection gas is guided along the curvature of the pipe bend (12) in the axial direction.

The invention relates to a forming device and a method for forming or for supplying at least one root protection gas to the root side of at least one region to be connected.

### PRIOR ART

The term “forming” refers to gassing or flushing with at least one root protection gas the root side and the heat-affected zone of a region to be connected. In this case, the region, facing away from the connecting device, of the region to be connected is referred to as the root side.

Furthermore, when a seam is connected in a plurality of layers, the lowest and/or first formed layer and, in the case of a seam formed only from one layer, the sub-region of the seam facing away from the connecting device is referred to as the root.

The term “connecting” hereinafter covers in particular not only welding, in particular all fusion welding methods, such as more particularly arc welding or also beam welding methods (and here in particular laser beam welding) but also arc soldering and mixed forms of welding and soldering.

Furthermore, the term “root protection gas” is used herein not only for pure root protection gases but also for root protection gas mixtures.

During forming, gases, such as argon, or inert gases, such as nitrogen, as well as mixtures of nitrogen and hydrogen (forming gases according to DIN EN 439) or argon and hydrogen, are usually used as root protection gas. The choice of root protection gas depends here on the materials to be processed, on the components, on the type of root protection gas supply and on the connection conditions. Root protection gases facilitate good root formation of the seam, improve the surface quality of the root and prevent scaling or discolorations in the connection region.

The function of the root protection gas during forming is to displace the oxygen-containing atmosphere and to secure a high-quality surface. In the case of connecting work on corrosion-resistant workpieces, for example, stainless steel, the seam and the seam zones oxidize when there is an unimpeded inflow of atmospheric oxygen, this being due to the connection heat in conjunction with the atmospheric oxygen, and discolorations occur.

Because the corrosion resistance of oxidized surfaces is greatly reduced, it is important when connecting objects made of stainless steel to ensure sufficient gas protection, even and particularly on the root side. The present invention therefore relates in particular to the protection of roots when connecting constructions made of stainless steel, primarily when connecting pipes made of stainless steel.

However, root protection for other materials is also covered by the present invention.

By means of forming, the formation of discolorations and oxidation in the region to be connected is prevented by the use of root protection gas, optionally in conjunction with a technical device, a so-called forming device.

Known forming devices usually bring the root protection gas directly to the connection point by suitable arrangement of sealing lips and diffusers inside the pipe and keep away the atmospheric oxygen. In the welding of stainless steel pipes, forming devices are used to block off a short section of the pipe and fill it with the root protection gas, thereby preventing or at least reducing undesired root-side seam oxidation and preventing discolorations.

The main advantages of the forming device are saving gas and a more effective seam protection. In order to achieve corrosion-resistant connecting seams, the residual oxygen content at the root side is preferably reduced to a maximum of about thirty parts per million (ppm).

Conventional forming devices are based on two different principles: either the space to be flushed is completely flooded with root protection gas, wherein low flow velocities prevail, or the seam is radially blown on directly. Although this ensures that the oxygen content is reduced to the required quantity directly at the seam, discolorations often still occur at the connections.

Characteristic of these discolorations is that they occur predominantly next to the seam and occasionally also on the seam. Even with perfect forming in the technical sense, i.e., at 0 ppm residual oxygen content, these discolorations are possible.

DE 10 2007 058 804 A1 discloses a forming device which is based on the principle that a root protection gas flow is guided in the direction along the root side of the region to be connected, in particular in the axial direction with respect to the object and/or in a plane substantially parallel to the region of the object to be connected, for example, along the inner wall of the pipe to be connected.

The root protection gas thus flows in a directed manner along a surface (which in principle has an arbitrary shape) of the object, for example, along and/or transversely to the seam. This directed root protection gas flow gives rise to vapors which may escape from the base material of the object, for example, from the pipe material, to be guided away from the connection point or from the region to be connected so that these vapors cannot deposit in the region of the seam. This example thus ensures a bright metallic seam formation without any color change, i.e., without discolorations (chromium oxides) and without color changes and deposits.

FIG. 1 shows a forming device 100 which is suitable for this purpose and is known from the prior art. A root protection gas conducting device 110 is formed in the form of a cylindrical displacement body, which can be inserted in a centered manner into a pipe 10. The lateral surfaces and the left-hand end face of the displacement body 110 are closed. A root protection gas supply device 120 in the form of a diffuser is arranged between the left-hand end face and a sealing element 130. The root protection gas supply device 120 introduces the root protection gas into the intermediate space between the seal 130 and the left-hand end face so that here an overpressure arises, due to which the root protection gas flows into the intermediate space between the lateral surface of the cylindrical displacement body 110 and the pipe 10. As a result, a flow is generated in the axial pipe direction so that the supplied root protection gas is conducted in the direction along the root side of the region to be connected at least in the region of the root side of the welding point or of the region 11 to be connected. Arranged to the right of the displacement body 110 is a centering element 140 which permits the passage of gas, whereby the displacement body can be centered in the pipe and whereby the generated root gas flow can flow onward. Connected to the left of the seal 130 is a gas supply line 160 through which the root gas is guided into the root gas supply device 120.

The illustrated forming device is designed in particular for use in straight pipes. Due to its size and stiffness, the forming device cannot be guided through a pipe bend.

The aim of the invention is to enable forming in a pipe bend.

### DISCLOSURE OF THE INVENTION

The invention proposes a forming device and a method for forming or for supplying at least one root protection gas to the root side of at least one region to be connected of at least one pipe according to the independent claims. Advantageous developments result from the respective dependent claims and the following description.

### ADVANTAGES OF THE INVENTION

According to the invention, the root protection gas supply device is arranged within the root protection gas conducting device.

This is advantageous since, as a result, the forming device can be designed to be substantially more compact than, for example, the forming device of FIG. 1. As a result, the forming device can also be brought from one end up to the curvature region of a pipe bend or even guided through a pipe bend.

In an advantageous embodiment, an end face of the cylindrical root protection gas conducting device is at least partially open so that the root protection gas can flow from the root protection gas supply device in the root protection gas conducting device through the end face over an edge of the cylindrical root protection gas conducting device into an intermediate space between the lateral surface of the root protection gas conducting device, which functions as displacement body, and into the pipe and is thus conducted at least in the region of the root side in the direction along the root side of the region to be connected. This makes possible a compact construction which in a simple way allows a root protection gas flow in the axial direction along the inner wall of the pipe along the root side of the region to be connected at low gas consumption, even when the region to be connected is an edge region of a pipe bend. In this case, it is advantageous if the other end face of the cylindrical root protection gas conducting device is closed off at least partially, preferably completely, so that a directed root gas flow from the open end face is generated.

The lateral surface of the cylindrical root protection gas conducting device expediently has at least one hole, wherein the root protection gas supply device furthermore interacts with the root protection gas conducting device in such a way that supplied root protection gas is conducted radially from inside to outside through the hole.

The root protection gas conducting device must be placed such that the flow through the at least one hole is directed into a curvature of the pipe bend. This ensures a protection gas flow which covers that curvature of the pipe bend which is not or barely encompassed by the gap flow and here too prevents the formation of manganese lines. The root protection gas is guided along the curvature of the pipe bend as a result of the root protection gas being radially guided from inside to outside in addition to the axial direction. As a result, even in the case of curved pipe bends, the principle is satisfied that a root protection gas flow be guided in the direction along the root side of the region to be connected, in particular in the axial direction with respect to the object and/or in a plane substantially parallel to the region to be connected of the object, for example, along the inner wall of the pipe to be connected.

Advantageously, the lateral surface has the hole in the axial direction closer to one end of the lateral surface than to a center of the lateral surface, in particular close to the substantially or completely closed-off end face of the root protection gas conducting device, whereby a root protection gas flow with a radial component and thus along a curvature of a pipe bend is generated preferably when the pipe is being connected to a pipe bend. It is conceivable that the lateral surface of the cylindrical root protection gas conducting device has a plurality of holes, preferably 2 to 30, more preferably 5 to 20. In this way, a root protection gas flow along an entire curvature of a pipe bend is preferably made possible.

The forming device expediently has at least one sealing element which can be inserted into the pipe for at least partially sealing the supplied root protection gas in an axial pipe direction. Advantageously, the sealing element is arranged at the end of the root protection gas conducting device where the at least partially open end face is located. In this way, the root protection gas can flow from the root protection gas supply device in the root protection gas conducting device through the at least partially open end face into the intermediate space between the seal and the left-hand cut surface so that here an overpressure arises, as a result of which the root protection gas flows into the intermediate space between the lateral surface of the cylindrical displacement body, or of the cylindrical root protection gas conducting device, and into the pipe. As a result, a flow is generated in the axial pipe direction so that the supplied root protection gas is conducted at least in the region of the root side in the direction along the root side of the region to be connected.

In a further advantageous embodiment, the forming device has at least one centering element which can be inserted into the pipe and in particular permits the passage of gas, and is for centering the root protection gas conducting device. In particular, the root protection gas conducting device, which functions as a displacement body, can thereby be held in a central pipe position so that an intermediate space is uniformly formed between the lateral surface of the cylindrical root protection gas conducting device and the pipe.

The at least one centering element is expediently arranged in the axial direction only at one end with respect to the root protection gas conducting device. As a result, a compact construction is advantageously made possible, as a result of which the root protection gas conducting device can be brought up very close to a pipe bend.

Advantageously, the at least one centering element and the at least one sealing element are both arranged at the same end with respect to the root protection gas conducting device in the axial direction. This is expediently the end where the end face is at least partially open. In this way, the root protection gas conducting device can be brought up very close to a pipe bend in the axial direction.

In an advantageous embodiment, the root protection gas supply device is a diffuser. This is advantageous since the supplied root protection gas can in this way be distributed particularly well in the root protection gas conducting device and can form a root protection gas flow to the open end face over an edge of the cylindrical root protection gas conducting device into an intermediate space between the lateral surface of the root protection gas conducting device and preferably through the hole in the lateral surface in the radial direction.

According to an additional aspect of the invention, a method is proposed for forming or for supplying at least one root protection gas to the root side of at least one region to be connected of at least one pipe, wherein the supplied root protection gas is guided, conducted, or deflected in the direction along an inner face of the pipe along the root side of the region to be connected, wherein the root protection gas is additionally guided in the radial direction so that when the pipe region is connected to a pipe bend, the root protection gas is guided along a curvature of the pipe bend in the axial direction. This is advantageous since it ensures a protection gas flow which covers the curvature of the pipe bend which is not or barely encompassed by the gap flow and here too prevents the formation of manganese lines. As a result of the root protection gas being radially guided from inside to outside in addition to in the axial direction, the root protection gas is guided along the curvature of the pipe bend so that, even in the case of curved pipe bends, the principle is satisfied that a root protection gas flow be guided in the direction along the root side of the region to be connected, in particular in the axial direction with respect to the object and/or in a plane substantially parallel to the region to be connected of the object, for example, along the inner wall of the pipe to be connected.

Argon, nitrogen and/or hydrogen is expediently used as the root protection gas. These are advantageous gases for preventing discolorations.

Advantageously, a forming device as described above is used for the method.

Further advantages and embodiments of the invention arise from the description and the accompanying drawings.

It is to be understood that the features mentioned above and yet to be explained below may be used not only in the particular combination specified but also in other combinations or by themselves, without departing from the scope of the present invention.

The invention is schematically illustrated in the drawings with reference to some exemplary embodiments and is described below with reference to the drawings.

### BRIEF DESCRIPTION OF THE DRAWINGS

FIG. 1 shows a forming device from the prior art;

FIG. 2 shows an embodiment of a forming device according to the invention;

FIGS. 3A-3H show steps in a welding method for a pipe bend at two open pipe ends using an embodiment of a forming device according to the invention;

FIGS. 4A-4H show steps in a welding method for a pipe bend at an open and a closed pipe end using an embodiment of a forming device according to the invention.

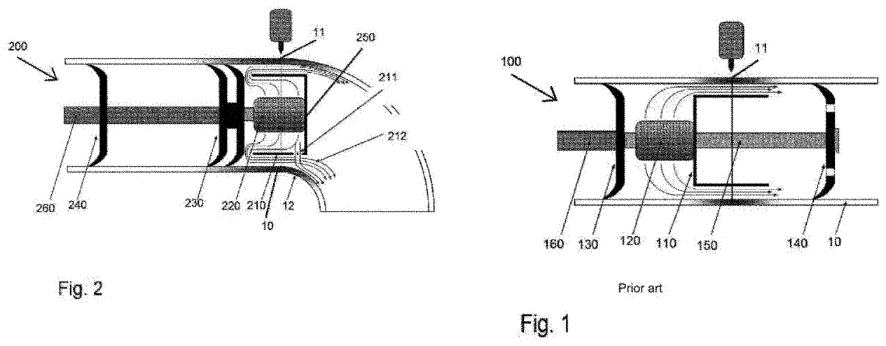

FIG. 1 has already been explained in the introduction of the description.

FIG. 2 shows an embodiment of a forming device according to the invention denoted by 200. The forming device 200 is here arranged in a pipe 10 which is currently being welded to a pipe bend 12. The welding point is denoted by 11.

The forming device 200 for supplying at least one root protection gas to the root side of at least one region to be connected of a pipe 10 comprises a root protection gas supply device 220 for supplying the root protection gas, said supply device here taking the form of a diffuser, and a root protection gas conducting device 210 for guiding or deflecting the supplied root protection gas in the axial direction along the inner wall of the pipe 10 along the root side of the region to be connected, said conducting device functioning as a displacement body. The root protection gas conducting device 210 has a cylindrical shape and can be inserted in a centered manner into the pipe. The root protection gas supply device 220 is arranged within the root protection gas conducting device 210. Root gas is guided into the root protection gas supply device 220 via a root gas supply line 260 on the left-hand side of the figure.

An end face of the cylindrical root protection gas conducting device 220 is at least partially open so that the root protection gas can flow from the root protection gas supply device 220 in the root protection gas conducting device 210 through the end face over an edge of the cylindrical root protection gas conducting device 210 into an intermediate space between the lateral surface of the root protection gas conducting device 210 acting as displacement body and into the pipe and thus is conducted at least in the region of the root side in the direction along the root side of the region 11 to be connected. The other end face of the cylindrical root protection gas conducting device 210 is completely closed off so that a directed root gas flow is generated from the open end face.

The lateral surface of the cylindrical root protection gas conducting device 210 has at least one hole 211, wherein the root protection gas supply device 220 furthermore interacts with the root protection gas conducting device 210 in such a way that supplied root protection gas is conducted radially from inside to outside through the hole 211. Here, the root protection gas conducting device 210 is placed such that the flow through the at least one hole 211 is directed into a curvature of the pipe bend 12. This provides a protection gas flow which covers the curvature of the pipe bend 12 that is not encompassed by the gap flow and also prevents the formation of manganese lines here. As a result of the root protection gas guided from inside to outside in addition to in the axial direction, the root protection gas is guided along the curvature of the pipe bend 12 so that, even in the case of curved pipe bends 12, the principle is satisfied that a root protection gas flow be guided in the direction along the root side of the region to be connected, in particular in the direction toward the object and/or in a plane substantially parallel to the region to be connected of the object, for example, along the inner wall of the pipe to be connected.

The forming device 200 has a sealing element 230 which can be inserted into the pipe 10 for at least partially sealing the supplied root protection gas in an axial pipe direction. The sealing element 230 is here arranged on the side of the root protection gas conducting device 210 where the at least partially open end face is located. In this way, the root protection gas can flow from the root protection gas supply device 220 in the root protection gas conducting device 210 through the at least partially open end face into the intermediate space between the seal and the left end face so that here an overpressure arises, through which the root protection gas flows into the intermediate space between the lateral surface of the cylindrical displacement body 210, or the cylindrical root protection gas conducting device 210, and into the pipe 10.

The forming device 200 furthermore comprises a centering element 240 which can be inserted into the pipe 10 for centering the root protection gas conducting device. In addition, a gas connection 250 is arranged on the other end face in order to reconnect the gas supply line 260.

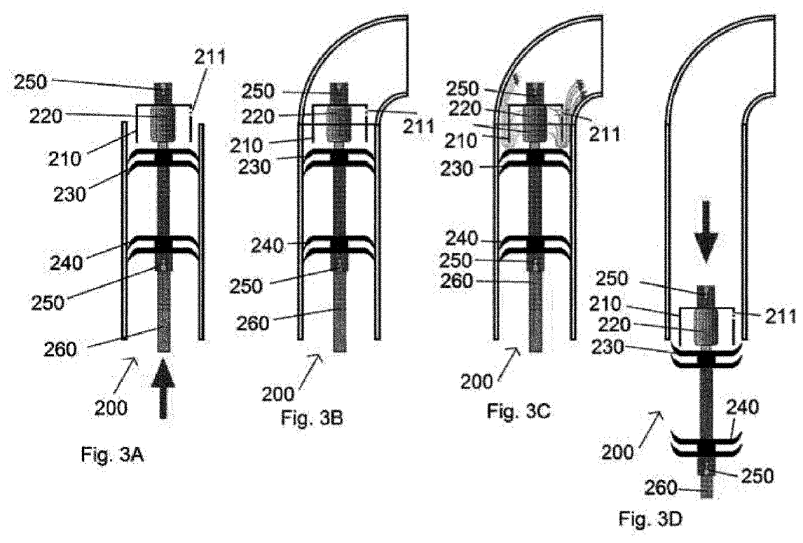

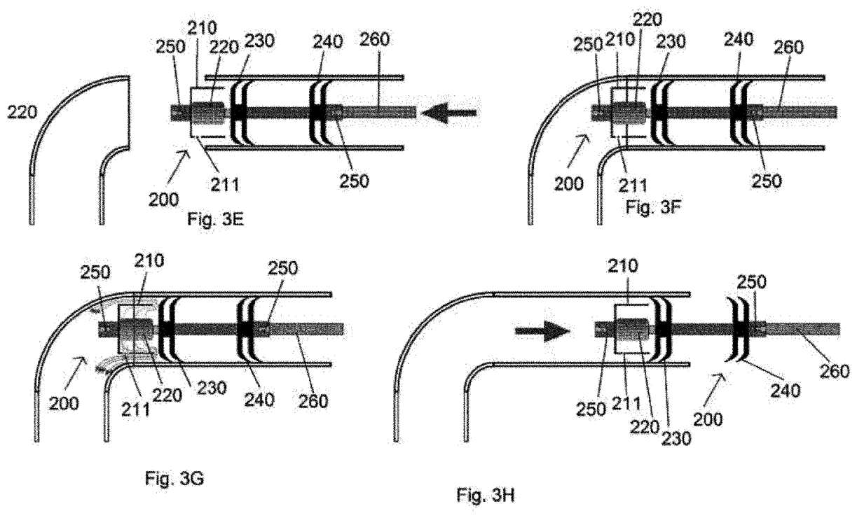

FIGS. 3A-3H show steps in a welding method for a pipe bend at two open pipe ends using an embodiment of a forming device 200 according to the invention.

FIG. 3A shows how the forming device 200 is inserted into an open pipe in such a way that the sealing element 230 and the centering element 240 remain in the pipe while the root protection gas conducting device 210 partially projects from the pipe. The forming device 200 has two gas connections 250, one on the end of the centering element 240, the other on the end of the root protection gas conducting device 210. The gas supply line 260 is connected to the gas connection 250 which is arranged at the centering element. Now, in FIG. 3B, a pipe bend is placed on the end of the pipe from which the root protection gas conducting device 210 projects. In FIG. 3C, a forming method according to the invention is carried out, wherein the pipe is welded to the pipe bend. In FIG. 3D, the forming device 200 is removed back through the pipe. In FIG. 3E, the forming device 200 is inserted into another open pipe, also in such a way that the sealing element 230 and the centering element 240 remain in the pipe while the root protection gas conducting device 210 partially projects from the pipe. In FIG. 3F, the other end of the pipe bend is placed on the end of the pipe from which the root protection gas conducting device 210 projects. In FIG. 3G, a forming method according to the invention is again carried out, wherein the pipe is welded to the pipe bend. In FIG. 3H, the forming device 200 is removed from the pipe.

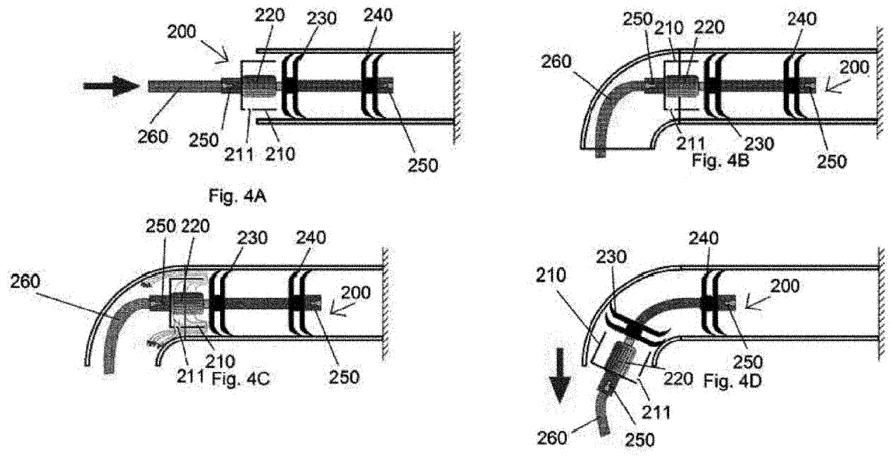

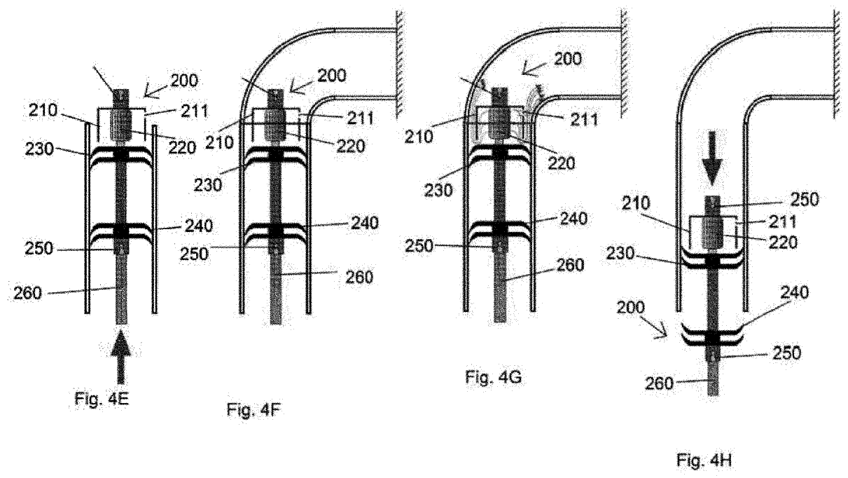

FIGS. 4A-4H show steps in a welding method for a pipe bend to an open and a closed pipe end using an embodiment of a forming device 200 according to the invention.

In this case, the gas supply line 260 is initially arranged at the gas connection 250. In FIG. 4A, the forming device 200 is inserted into a pipe closed at one end in such a way that the sealing element 230 and the centering element 240 remain in the pipe while the root protection gas conducting device 210 partially projects from the open end of the pipe. The gas supply line 260 also projects with one of the gas connections 250 from the open end of the pipe. Now, in FIG. 4B, a pipe bend is placed on the end of the pipe from which the root protection gas conducting device 210 projects. In FIG. 4C, a forming method according to the invention is carried out, wherein the pipe is welded to the pipe bend. In FIG. 4D, the forming device 200 is removed through the pipe bend.

The gas supply line 260 is then attached to the other gas connection 250. The steps in FIGS. 4E-4H then correspond to the steps in FIGS. 3E-3H.

### REFERENCE NUMBERS

10 Pipe
11 Region to be connected, welding point
12 Pipe bend
100 Forming device (prior art)
110 Root protection gas conducting device, displacement body
120 Root protection gas supply device
130 Sealing element
140 Centering element
160 Gas supply line
200 Forming device
210 Root protection gas conducting device, displacement body
211 Hole
212 Flow deflection
220 Root protection gas supply device
230 Sealing element
240 Centering element
250 Gas connection
260 Gas supply line

1. Forming device (200) for supplying at least one root protection gas to the root side of at least one region (11) to be connected of at least one pipe (10) and for supplying the root protection gas along a curvature of the pipe bend in the axial direction, comprising at least one root protection gas supply device (220) for supplying the root protection gas and comprising at least one root protection gas conducting device (210) for guiding or deflecting the supplied root protection gas in the axial direction along the inner wall of the pipe (10) along the root side of the region (11) to be connected, wherein the root protection gas conducting device (210) has a cylindrical shape and can be inserted into the pipe (10) in a centered manner, characterized in that the root protection gas supply device (220) is arranged within the root protection gas conducting device (210).

2. Forming device (200) according to claim 1, characterized in that an end face of the cylindrical root protection gas conducting device (210) is at least partially open so that the root protection gas can flow from the root protection gas supply device (220) in the root protection gas conducting device (210) through the end face over an edge of the cylindrical root protection gas conducting device (210) into an intermediate space between the lateral surface of the root protection gas conducting device (210) and the pipe (10) and thus is conducted at least in the region of the root side in the direction along the root side of the region (11) to be connected.

3. Forming device (200) according to claim 1, characterized in that the lateral surface of the cylindrical root protection gas conducting device (210) has at least one hole (211), wherein the root protection gas supply device (220) furthermore interacts with the root protection gas conducting device (210) in such a way that supplied root protection gas is conducted radially from inside to outside through the hole (211).

4. Forming device (200) according to claim 3, characterized in that the lateral surface has the hole (211) in the axial direction closer to one end of the lateral surface than to a center of the lateral surface.

5. Forming device (200) according to claim 1, characterized by at least one sealing element (230) which can be inserted into the pipe (10) for at least partially sealing the supplied root protection gas in an axial pipe direction.

6. Forming device (200) according to claim 1, characterized by at least one centering element (240), which can be inserted into the pipe (10) and in particular permits the passage of gas, for centering the root protection gas conducting device (210).

7. Forming device (200) according to claim 6, wherein the at least one centering element (240) is arranged in the axial direction only at one end with respect to the root protection gas conducting device (210).

8. Forming device (200) according to claim 6, characterized by at least one sealing element (230) which can be inserted into the pipe (10) for at least partially sealing the supplied root protection gas in an axial pipe direction, wherein the at least one centering element (240) and the at least one sealing element (230) are arranged in the axial direction only at one end with respect to the root protection gas conducting device (210).

9. Forming device (200) according to claim 1, wherein the root protection gas supply device (220) is a diffuser.

10. Method for forming or for supplying at least one root protection gas to the root side of at least one region (11) to be connected of at least one pipe (10), wherein the supplied root protection gas is guided, conducted, or deflected in the direction along an inner face of the pipe (10) along the root side of the region to be connected, characterized in that the root protection gas is additionally guided in the radial direction so that when the pipe region is connected to a pipe bend (12), the root protection gas is guided along a curvature of the pipe bend (12) in the axial direction.

11. Method according to claim 10, wherein argon, nitrogen and/or hydrogen are used as root protection gas.

12. Method according to claim 10, that uses a forming device (200) for supplying at least one root protection gas to the root side of at least one region (11) to be connected of at least one pipe (10) and for supplying the root protection gas along a curvature of the pipe bend in the axial direction, comprising at least one root protection gas supply device (220) for supplying the root protection gas and comprising at least one root protection gas conducting device (210) for guiding or deflecting the supplied root protection gas in the axial direction along the inner wall of the pipe (10) along the root side of the region (11) to be connected, wherein the root protection gas conducting device (210) has a cylindrical shape and can be inserted into the pipe (10) in a centered manner, characterized in that the root protection gas supply device (220) is arranged within the root protection gas conducting device (210).
